(19) United States
(12) Patent Application Publication
(10) Pub. No.: US 2013/0272714 A1
(43) Pub. Date: Oct. 17, 2013

(54) State Control System and State Control Method

(71) Applicant: HITACHI, LTD., Tokyo (JP)

(72) Inventors: Norio OHKUBO, Tokyo (JP); Yoshihiro WAKISAKA, Kunitachi (JP); Miki HAYAKAWA, Kawasaki (JP)

(73) Assignee: HITACHI, LTD., Tokyo (JP)

(21) Appl. No.: 13/846,370

(22) Filed: Mar. 18, 2013

(30) Foreign Application Priority Data
Apr. 11, 2012 (JP) 2012-090243

(51) Int. Cl. G08C 23/04

(52) U.S. Cl. CPC G08C 23/04
USPC 398/106; 340/5.6

(57) ABSTRACT

A state control system comprises a portable terminal and a control apparatus. The portable terminal sends a signal including identification information to an external. The control apparatus controls a controlled object in either one of a locked state and an unlocked state based on the signal sent from the portable terminal. The portable terminal sends a first signal, in a case where a event detector has not detected the event, and sends a second signal having a data length longer than a data length of the first signal, in a case where the event detector has detected the event. The control apparatus controls a controlled object to the unlocked state in a case where the controlled object is in the locked state and the controlled apparatus receives the second signal.

### CLAIM OF PRIORITY

The present application claims priority from Japanese patent application JP 2012-90243 filed on Apr. 11, 2012, the content of which is hereby incorporated by reference into this application.

### BACKGROUND OF THE INVENTION

This invention relates to a state control system for controlling an object to be in a locked state or an unlocked state, and in particular, relates to a state control system for controlling the object to be in a locked state or an unlocked state based on a signal sent by a portable terminal.

As information becomes more sophisticated, information security problems are becoming more serious; it is particularly desired to improve the security in accessing a room or an information apparatus.

For a security system for controlling access to a room, there is a known system that unlocks a room door upon successful authentication with an ID card waved over a card reader for the room. For a security system for controlling access to an information apparatus, there is a known system that unlocks the information apparatus by entering a correct password to the information apparatus.

With these systems, however, the user has to wave an ID card over a reader or enter a password; these efforts are bothersome for the user.

To cope with this problem, there is a known room access control system which does not require an ID card to be waived over a reader (for example, refer to JP 2007-107194 A). With the room access control system according to JP 2007-107194 A, information in an ID tag (portable terminal) held by a person permitted to access the room is read by an ID reader hands-free and the room door is unlocked only when the person permitted to access the room holding the ID tag is determined to be standing still by an approach detection sensor.

### SUMMARY OF THE INVENTION

In general, high-security communication is required to unlock a controlled object; accordingly, signals to be used in such communications may need to have a bit length of 256 bits. If a portable terminal frequently sends such signals to unlock the controlled object, the portable terminal consumes more power.

To cope with the increase in power consumption of a portable terminal, the portable terminal requires a larger battery or more frequent battery charging, if the portable terminal has a battery. If the portable terminal generates a power for sending a signal by receiving electric waves from a reader, the portable terminal requires a larger antenna for receiving the electric waves from the reader. The increase in size of the battery or the receiving antenna causes increase in size of the portable terminal.

In the room access control system according to JP 2007-107194 A, an ID tag sends a signal to unlock the door if the user is positioned close to the door; consequently, the portable terminal cannot save its power consumption.

In view of the above, this invention aims to provide a state control system that can save the power consumption of the portable terminal while maintaining the security level.

According to an aspect of the present invention, there is provided A state control system comprising: a portable terminal for sending a signal including identification information to an external; and a control apparatus for controlling a controlled object in either one of a locked state and an unlocked state based on the signal sent from the portable terminal, wherein the portable terminal includes has an event detector for detecting a predetermined event, wherein, in a case where the event detector has not detected the event, the portable terminal sends a first signal, wherein, in a case where the event detector has detected the event, the portable terminal sends a second signal having a data length longer than a data length of the first signal, wherein, in a case where the controlled object is in the locked state and the controlled apparatus receives the second signal from the portable terminal, the control apparatus controls the controlled object to the unlocked state, and wherein, in a case where the controlled object is in the unlocked state and the controlled apparatus has received neither the first signal nor the second signal for a predetermined period from the portable terminal, the control apparatus controls the controlled object to the locked state.

A brief description is now given of effects provided by the exemplary embodiment of this invention disclosed in this application. This invention enables to provide a state control system that can save the power consumption of the portable terminal while maintaining the security level.

### BRIEF DESCRIPTION OF THE DRAWINGS

The present invention can be appreciated by the description which follows in conjunction with the following figures, wherein:

FIG. 1 is an explanatory diagram illustrating a configuration of a room access control system in a first embodiment of this invention;

FIG. 2 is an explanatory diagram illustrating a configuration of a portable terminal in the first embodiment of this invention;

FIG. 3 is a functional block diagram of the room access control system in the first embodiment of this invention;

FIG. 4 is a sequence diagram of the room access control system in the first embodiment of this invention;

FIG. 5 is a timing chart illustrating operations of the portable terminal and an infrared transmitter/receiver in the first embodiment of this invention;

FIG. 6 is an explanatory diagram illustrating a method of authenticating identification information included in a first signal by an authentication unit in the first embodiment of this invention;

FIG. 7 is an explanatory diagram illustrating a method of authenticating identification information included in a second signal by the authentication unit in the first embodiment of this invention;

FIG. 8 is an explanatory diagram illustrating infrared transmission and receiving by the portable terminal in the first embodiment of this invention;

FIG. 9A is a circuit diagram of a modulator circuit in the first embodiment of this invention;

FIG. 9B is a timing chart of the modulator circuit in the first embodiment of this invention;

FIG. 10A is a circuit diagram of a demodulator circuit in the first embodiment of this invention;

FIG. 10B is a timing chart of the modulator circuit in the first embodiment of this invention;

FIG. 11 is a sequence diagram of a modified example of the room access control system in the first embodiment of this invention;

FIG. 12 is a configuration diagram of the state control system for information apparatus in a second embodiment of this invention;

FIG. 13 is a sequence diagram of a state management system for information apparatus in the second embodiment of this invention;

FIG. 14A is an explanatory diagram illustrating state transitions of the information apparatus in the second embodiment of this invention;

FIG. 14B is an explanatory diagram illustrating state transitions of a portable terminal in the second embodiment of this invention; and

FIG. 15 is a sequence diagram of a state control system for information apparatus in the modified example of the second embodiment of this invention.

### DETAILED DESCRIPTION OF THE EMBODIMENTS

### First Embodiment

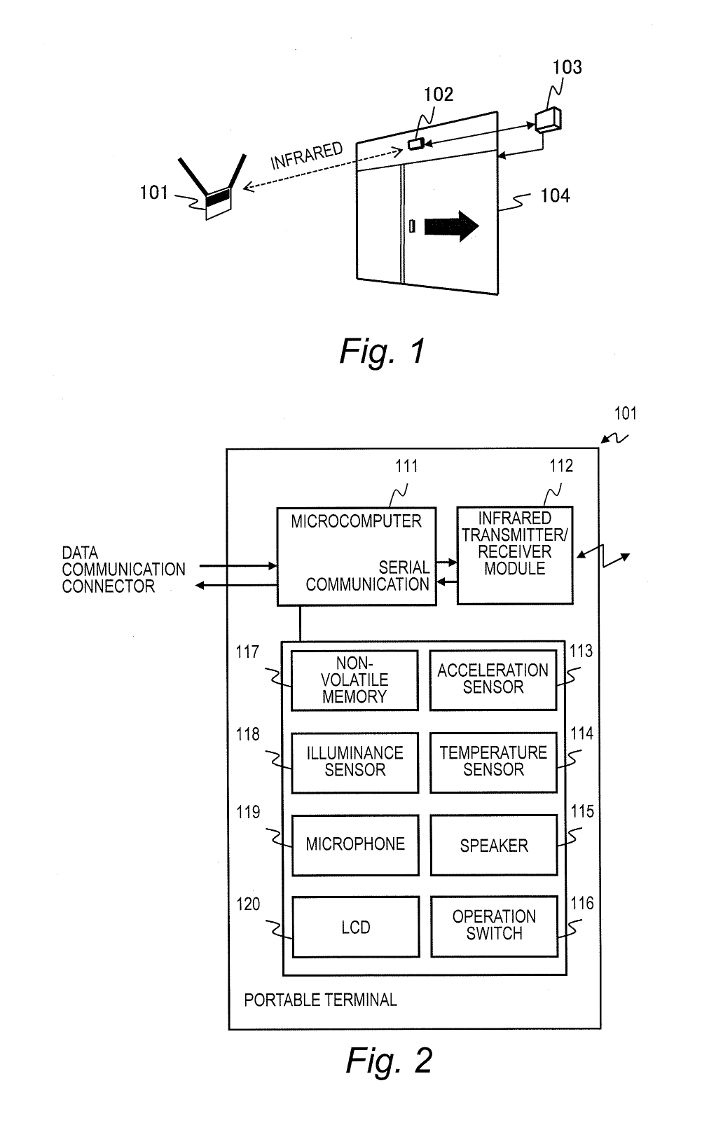

A first embodiment of this invention is described using FIGS. 1 to 11.

FIG. 1 is an explanatory diagram illustrating a configuration of a room access control system in the first embodiment.

The room access control system includes a portable terminal 101 held by a user, an infrared transmitter/receiver 102, a controller (control apparatus) 103, and an automatic door (controlled object) 104.

The portable terminal 101 sends a signal including identification information to an external via infrared and receives an infrared signal from the external. The infrared transmitter/receiver 102 sends the signal sent from the portable terminal 101 to the controller 103 and sends a request for a signal to the portable terminal 101.

The controller 103 authenticates the signal sent from the portable terminal 101 and controls the state of the automatic door 104, whether or not to lock the automatic door 104, based on the signal sent from the portable terminal 101. The automatic door 104 has an unlocked state in which the door is open and a locked state in which the door is closed.

The infrared transmitter/receiver 102 and the controller 103 may be installed in a single enclosure.

FIG. 2 is an explanatory diagram illustrating a configuration of the portable terminal 101 in the first embodiment.

The portable terminal 101 includes a microcomputer 111, an infrared transmitter/receiver module 112, an acceleration sensor 113, a temperature sensor 114, a speaker 115, an operation switch 116, a non-volatile memory 117, an illuminance sensor 118, a microphone 119, and an LCD 120.

The microcomputer 111 performs arithmetic processing to control the portable terminal 101. The infrared transmitter/receiver module 112 communicates signals with the infrared transmitter/receiver 102 via infrared.

The acceleration sensor 113 measures an acceleration of the portable terminal 101. The temperature sensor 114 measures a temperature around the portable terminal 101. The speaker 115 outputs a sound indicating an operation or a state of the portable terminal 101. The user can know the operation or the state of the portable terminal 101 through the sound output from the speaker 115. The operation switch 116 is a switch operated by the user.

The non-volatile memory 117 stores a user ID and others. The illuminance sensor 118 measures an illuminance around the portable terminal 101. The microphone 119 captures sounds around the portable terminal 101. The LCD 120 displays an operation or a state of the portable terminal 101.

The portable terminal 101 in this embodiment does not have to include all the components but is sufficient to include at least the microcomputer 111, the infrared transmitter/receiver module 112, and the acceleration sensor 113.

As described above, the portable terminal 101 and the infrared transmitter/receiver 102 communicate signals via infrared. Since the infrared light has higher directivity than the radio frequency (RF) wave, the portable terminal 101 and the infrared transmitter/receiver 102 can communicate signals only when the infrared transmitter/receiver module 112 in the portable terminal 101 faces the infrared transmitter/receiver 102. Accordingly, the automatic door 104 can be prevented from erroneously opening when a user holding the portable terminal 101 crosses in front of the automatic door. Because of this point, the infrared communication is more suitable for an access control system than the RF communication.

It is preferable that the user hold the portable terminal 101 by dangling it from the neck. The portable terminal 101 which is held by a user by dangling from the user's neck is referred to as tag-type portable terminal.

Next, using FIGS. 1 and 2, a method of controlling the state of the automatic door 104 by the room access control system is simply explained.

The microcomputer 111 in the portable terminal 101 determines whether the user is standing still based on a result of measurement of acceleration by the acceleration sensor 113 shown in FIG. 2. If the user is not standing still, meaning that the user is walking, the portable terminal 101 sends a first signal. If the user is standing still, the portable terminal 101 sends a second signal. As will be described later, the second signal is a signal to be used to unlock the automatic door 104; accordingly, it has a longer bit length than the first signal.

The infrared transmitter/receiver 102, upon receipt of a signal, sends the received signal to the controller 103 if the received signal is from the portable terminal 101. Since the infrared transmitter/receiver 102 may be affected by lighting equipment to erroneously receive signals other than the signal from the portable terminal 101, the infrared transmitter/receiver 102 is configured to send only the signals from the portable terminal 101, preventing it from sending unnecessary signals to the controller 103.

The infrared transmitter/receiver 102 may be connected to the controller with wire or wirelessly.

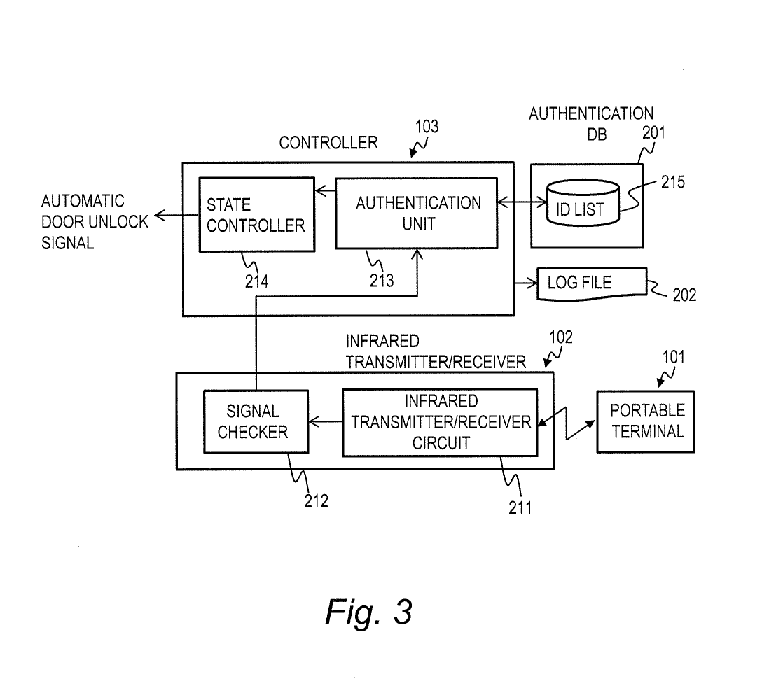

When the automatic door 104 is in the locked state, the controller 103 receives a second signal and, if the identification information included in the second signal is authenticated successfully, it controls the automatic door 104 into the unlocked state. When the automatic door 104 is in the unlocked state, the controller 103 receives a first signal and, if the identification information included in the first signal is authenticated successfully, it stores the identification information included in the received first signal in a log file 202 shown in FIG. 3. Furthermore, when the automatic door 104 is in the unlocked state, the controller 103 controls the automatic door 104 to the locked state if it has not received a first signal for a predetermined continuous period.

To unlock the automatic door 104 through the foregoing operations, the user is required to stand still for a while in front of the automatic door 104. As a result, the controller 103 can reduce the erroneous unlocking of the automatic door 104 when the user crosses in front of the automatic door 104.

The controller 103 can also store identification information included in a plurality of first signals from the portable terminals 101 of a plurality of users in the log file 202 when the plurality of users pass through the unlocked automatic door 104 at once.

The second signal to be used to unlock the automatic door 104 has a bit length longer than the first signal which is merely stored in the log file 202. The portable terminal 101 sends such a second signal only when the user is standing still, so that less frequent sending of a second signal can be achieved. This approach saves power consumption of the portable terminal 101 without lowering the security level.

Furthermore, since the portable terminal 101 and the infrared transmitter/receiver 102 communicate via infrared, the user does not need to either wave the card or input a password; hands-free access control can be provided to the user.

FIG. 3 is a functional block diagram of the room access control system in the first embodiment.

The infrared transmitter/receiver 102 includes an infrared transmitter/receiver circuit 211 and a signal checker 212. The infrared transmitter/receiver circuit 211 is a circuit for sending and receiving signals via infrared. The signal checker 212 determines whether a received signal is a signal sent from the portable terminal 101 and, if the received signal is a signal sent from the portable terminal 101, the signal checker 212 sends the received signal to the controller 103.

An authentication database (DB) 201 stores an ID list 215. The ID list 215 holds identification information which is to be consulted to verify an authentication of identification information included in a signal received by the controller 103. The log file 202 stores identification information included in the signals received by the controller 103 when the automatic door 104 is in the unlocked state. The authentication database 201 and the log file 202 are installed in a non-volatile memory such as a hard disk. The controller 103 may include the authentication database 201 and the log file 202 or a not-shown server connected to the controller 103 via a network may include the authentication database 201 and the log file 202. If one controller 103 controls a plurality of automatic doors, it is preferable that a server connected to a network include the authentication database 201 and the log file 202.

The controller 103 includes an authentication unit 213 and a state controller 214. The authentication unit 213 authenticates identification information included in a received signal with reference to the ID list 215. If the ID list 215 includes the identification information included in the received signal, the authentication unit 213 determines that the authentication of the identification information included in this signal is successful; if the ID list 215 does not include the identification information included in the received signal, it determines that the authentication of the identification information included in this signal is failed.

The state controller 214 identifies whether a signal authenticated by the authentication unit 213 is a first signal or a second signal and controls the state of the automatic door 104 based on the state of the automatic door 104 and the result of the identification. If the automatic door 104 is in the locked state and the received signal is a second signal, the state controller 214 sends an unlock signal to the automatic door 104. If the automatic door 104 is in the unlocked state and no first signal has been received for a predetermined continuous period, the state controller 214 sends a lock signal to the automatic door 104.

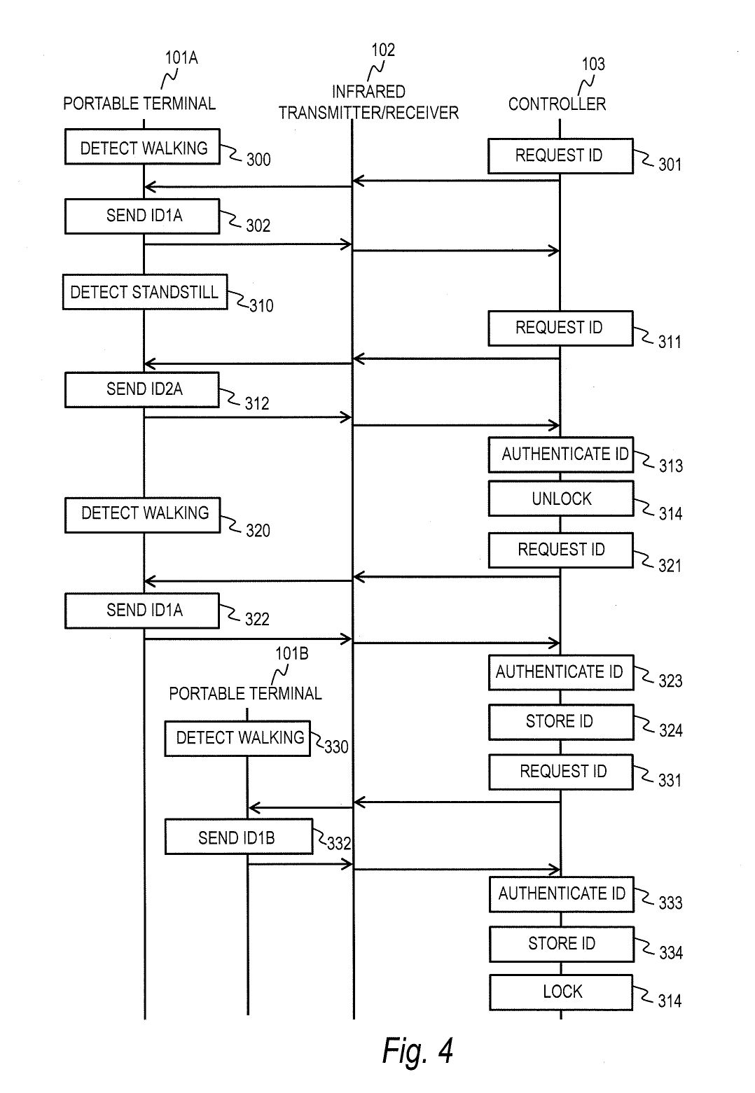

FIG. 4 is a sequence diagram of the room access control system in the first embodiment.

FIG. 4 omits the processing of the signal checker 212 in the infrared transmitter/receiver 102 and mainly explains communications between the portable terminal 101 and the controller 103.

The portable terminal 101 is in advance assigned first identification information to be included in the first signal and second identification information to be included in the second signal. The first identification information and the second identification information are assigned so as not to be common to those of the other portable terminals 101. In FIG. 4, the first identification information included in the first signal sent by a portable terminal 101A is denoted by ID1A and the second identification information included in the second signal sent by the same portable terminal 101A is denoted by ID2A.

For the controller 103 to easily identify the first identification information or the second identification information, it is preferable that the first identification information and the second identification information have different high-order bits.

FIG. 4 explains a situation that a user approaches the automatic door 104, stops in front of the automatic door 104 in the locked state, and passes through the automatic door 104 which has been unlocked.

First, the portable terminal 101A detects that the user is walking (300). Specifically, the microcomputer 111 in the portable terminal 101A detects whether the user is walking or standing still based on a result of measurement by the acceleration sensor 113.

Next, the controller 103 sends an ID request, which is a request for identification information, to the infrared transmitter/receiver 102 (301). The controller 103 sends such an ID request periodically (for example, at every 0.5 seconds). The infrared transmitter/receiver 102 sends the ID request sent from the controller 103 to the external.

When the portable terminal 101A receives the ID request sent from the infrared transmitter/receiver 102, it sends a first signal including ID1A to the external (302) because the portable terminal 101A has detected that the user is walking.

The infrared transmitter/receiver 102 receives the first signal sent from the portable terminal 101A and sends the received first signal to the controller 103. The controller 103 does not perform anything when it receives the first signal sent from the infrared transmitter/receiver 102 because the automatic door 104 is in the locked state.

Next, the portable terminal 101A detects that the user is standing still (310). The controller 103 sends an ID request to the infrared transmitter/receiver 102 (311); the infrared transmitter/receiver 102 sends the received ID request to the external.

When the portable terminal 101A receives the ID request sent from the infrared transmitter/receiver 102, it sends a second signal including ID2A to the external (312) because it has detected the user is standing still.

The infrared transmitter/receiver 102 receives the second signal sent from the portable terminal 101A and sends the received second signal to the controller 103. When the controller 103 receives the second signal sent from the infrared transmitter/receiver 102, it authenticates ID2A by determining whether the ID2A included in the received second signal is in registration of the ID list 215 (313).

If the authentication of ID2A at step 313 is successful, the controller 103 sends the automatic door 104 an unlock signal for controlling the automatic door 104 in the locked state into the unlocked state to control the automatic door 104 to the unlocked state (314).

Next, since the automatic door 104 has turned to the unlocked state, the user starts walking to pass through the automatic door 104. The portable terminal 101A detects that the user is walking (320). The controller 103 sends an ID request to the infrared transmitter/receiver 102 (321) and the infrared transmitter/receiver 102 sends the received ID request to the external.

When the portable terminal 101A receives the ID request sent from the infrared transmitter/receiver 102, it sends a first signal including ID lA to the external because it has detected the user is walking (322).

The infrared transmitter/receiver 102 receives the first signal sent from the portable terminal 101A and sends the received first signal to the controller 103. Upon receipt of the first signal sent from the infrared transmitter/receiver 102, the controller 103 authenticates ID1A included in the received first signal (323).

If the authentication of ID1A at step 323 is successful, the controller 103 stores the authenticated ID1A in the log file 202 (324) because the automatic door 104 is in the unlocked state.

Explained next is a case where another user holding a different portable terminal 101B is approaching the automatic door 104 when the automatic door 104 is in the unlocked state. In this case, the portable terminal 101B detects that the user is walking (330). The controller 103 sends an ID request to the infrared transmitter/receiver 102 (331); the infrared transmitter/receiver 102 sends the received ID request to the external.

When the portable terminal 101B receives the ID request sent from the infrared transmitter/receiver 102, it sends a first signal including ID1B to the external (332) because it has detected the user is walking.

The infrared transmitter/receiver 102 receives the first signal sent from the portable terminal 101B and sends the received first signal to the controller 103. Upon receipt of the first signal sent from the infrared transmitter/receiver 102, the controller 103 authenticates ID1B included in the received first signal (333).

If the authentication of ID1B at step 333 is successful, the controller 103 stores the authenticated ID1B in the log file 202 (334) because the automatic door 104 is in the unlocked state.

As described, the controller 103 stores first identification information included in the first signals received while the automatic door 104 is in the unlocked state in the log file 202; accordingly, it can manage the users who pass through the automatic door 104 while the automatic door 104 is in the unlocked state. The log file 202 stores first identification information having shorter bit length than second identification information, so that the data volume in the log file 202 can be saved.

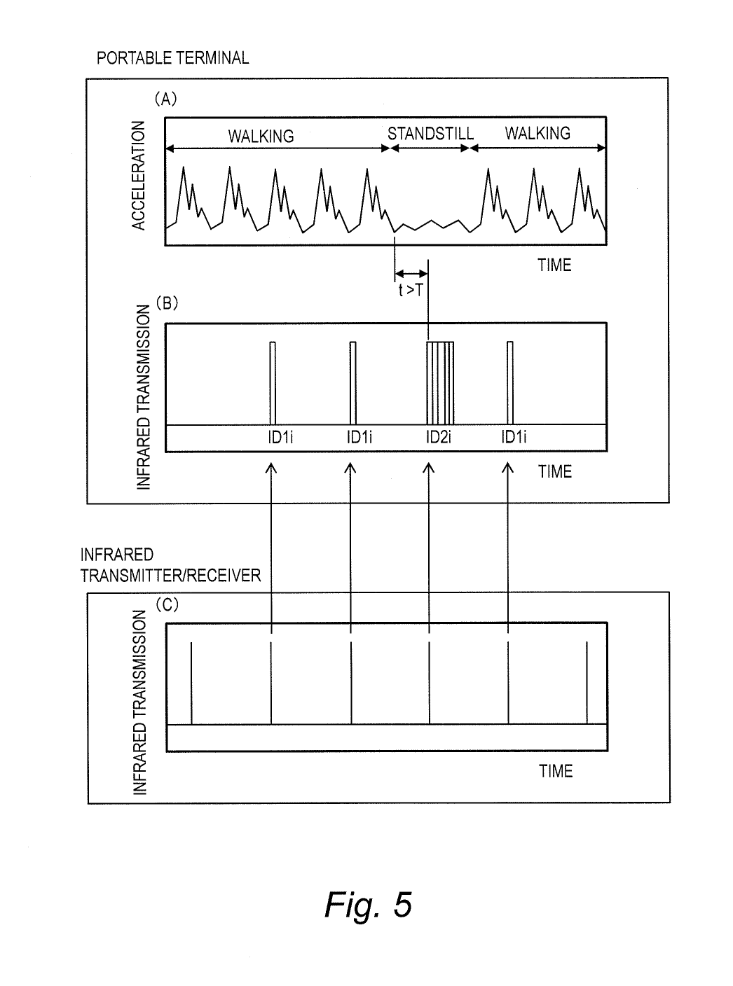

FIG. 5 is a timing chart illustrating operations of the portable terminal 101 and the infrared transmitter/receiver 102 in this invention.

The time chart (A) in FIG. 5 illustrates operations of the acceleration sensor 113 included in the portable terminal 101. As shown in (A) in FIG. 5, the waveform of the acceleration measured by the acceleration sensor 113 when a user is standing still differs from the waveform of the acceleration measured by the acceleration sensor 113 when the user is walking.

In this embodiment, the microcomputer 111 included in the portable terminal 101 determines that the user is standing still if a time period (t) in which the peak value of the acceleration is equal to or lower than a predetermined value is longer than a predetermined time period (T). This method provides accurate determination whether a user is standing still.

The time chart (B) in FIG. 5 illustrates operations of sending signals via infrared by the infrared transmitter/receiver module 112 included in the portable terminal 101. The time chart (C) in FIG. 5 illustrates operations of sending ID requests via infrared by the infrared transmitter/receiver 102.

As shown in (C) in FIG. 5, the infrared transmitter/receiver 102 sends ID requests to the external with a predetermined cycle. When the portable terminal 101 receives an ID request sent from the infrared transmitter/receiver 102, it sends a first signal including ID1 from the infrared transmitter/receiver module 112 if the user is walking, or sends a second signal including ID2 if the user is standing still.

As shown in (B) in FIG. 5, the time taken to send a second signal is longer than that to send a first signal because the second signal including ID2 has a longer bit length than the first signal including ID1

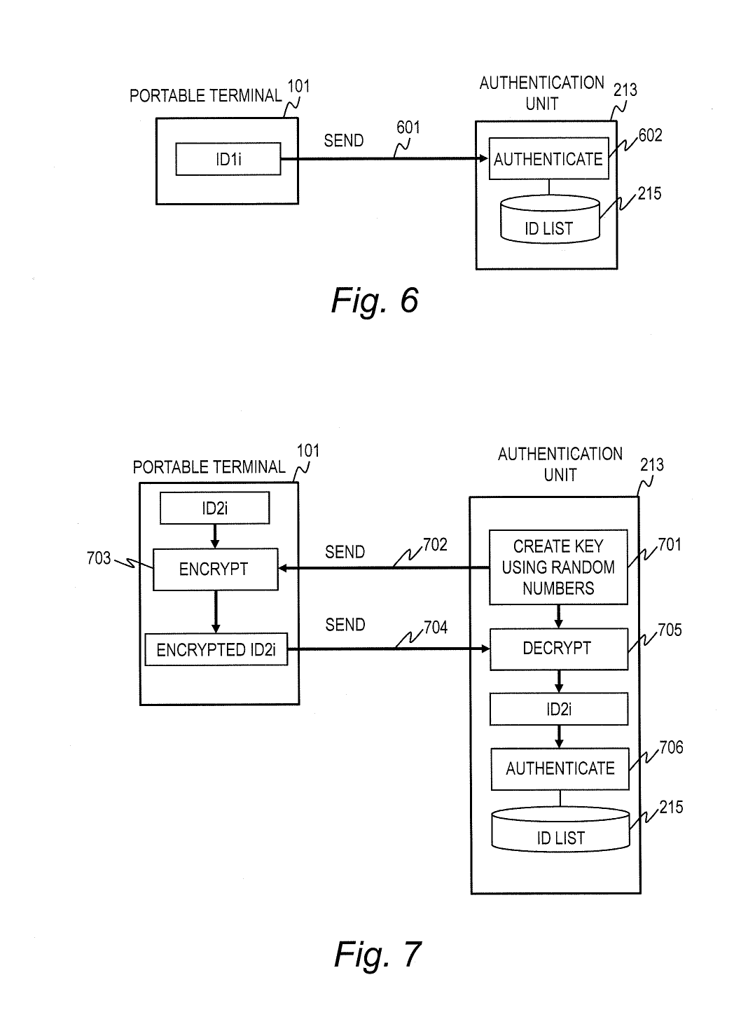

FIG. 6 is an explanatory diagram illustrating a method of authenticating identification information included in the first signal by the authentication unit 213 in the first embodiment.

The portable terminal 101 sends a first signal including ID1 (601). If the ID1 included in the first signal sent from the portable terminal 101 is in registration of the ID list 215, the authentication unit 213 in the controller 103 determines that the authentication is successful; or if the ID1 included in the first signal is not in registration of the ID list 215, the authentication unit 213 determines that the authentication is failed (602).

Since the first signal is sent from the portable terminal 101 for the purpose of storage in the log file 202, it is sent in a plain text without being encrypted as described above. Accordingly, it is sufficient that the first signal have a bit length of 32 bits.

FIG. 7 is an explanatory diagram illustrating a method of authenticating identification information included in the second signal by the authentication unit 213 in the first embodiment.

The authentication unit 213 in the controller 103 creates a key for encryption using random numbers (701) and includes the created key in an ID request to send it to the portable terminal 101 via the infrared transmitter/receiver 102 (702).

If the user is standing still when the portable terminal 101 receives the ID request, the portable terminal 101 encrypts ID2 using the key included in the received ID request (703), and sends a second signal including the encrypted ID2 to the controller 103 via the infrared transmitter/receiver 102 (704).

When the controller 103 receives the second request, the authentication unit 213 decrypts the encrypted ID2 included in the received second signal using the key (705). If the decrypted ID2 is in registration of the ID list 215, the authentication unit 213 determines that the authentication is successful; if the decrypted ID2 is not in registration of the ID list 215, the authentication unit 213 determines that the authentication is failed (706).

Since the second signal including ID2 is to unlock the automatic door 104 and requires higher security, it is encrypted to be sent as described above. The second signal may have a bit length of 256 bits.

FIG. 7 illustrates an example that the key is included in an ID request to be sent from the authentication unit 213 to the portable terminal 101; however, the authentication unit 213 does not need to include the key in an ID request to be sent if both of the authentication unit 213 and the portable terminal 101 originally have the same key.

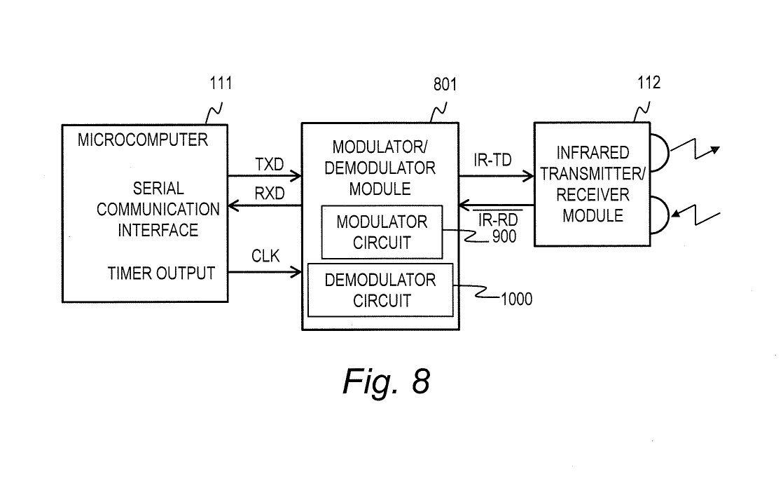

FIG. 8 is an explanatory diagram illustrating infrared transmission and receiving by the portable terminal 101 in the first embodiment.

The microcomputer 111 is connected to the infrared transmitter/receiver module 112 via a modulator/demodulator module 801.

First, operations in the case where the portable terminal 101 sends a signal via infrared are described.

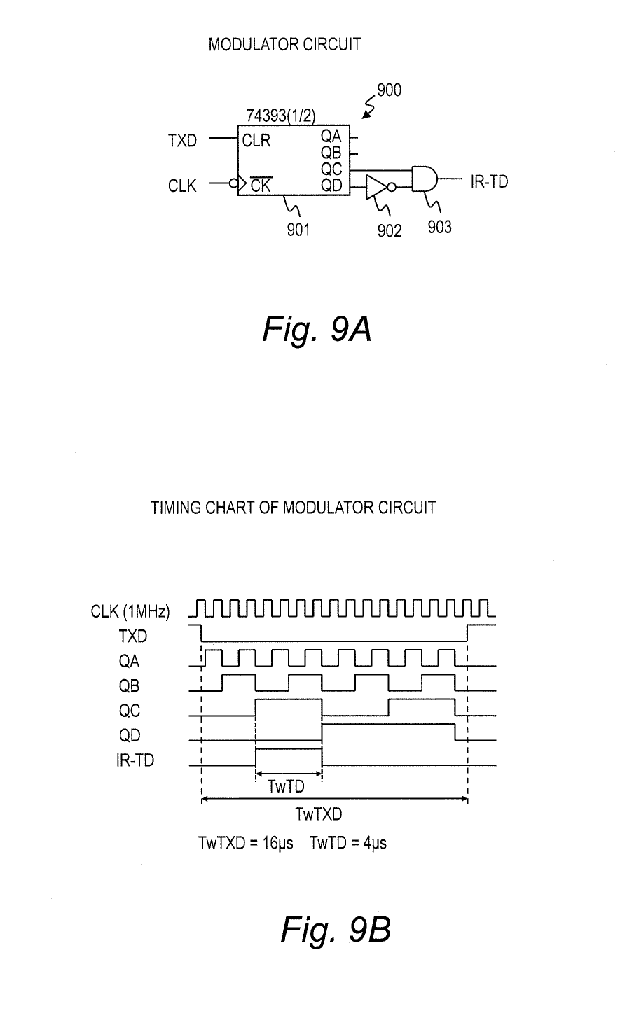

The microcomputer 111 feeds transmit data TXD to the modulator/demodulator module 801 via a serial communication interface. A modulator circuit 900 in the modulator/demodulator module 801 modulates the pulse width of the received transmit data so as to emit infrared light for a shorter time and feeds the obtained transmit data IR-TD to the infrared transmitter/receiver module 112. Upon receipt of the transmit data IR-TD, the infrared transmitter/receiver module 112 lights a not shown infrared-emitting diode based on the received transmit data IR-TD to send a signal via infrared. The modulator circuit 900 will be described in detail with reference to FIGS. 9A and 9B.

Next, operations in the case where the portable terminal 101 receives a signal via infrared are described.

The infrared transmitter/receiver module 112 receives incoming data such as an ID request sent from the infrared transmitter/receiver 102 through a not shown infrared photodetector. The infrared transmitter/receiver module 112 feeds the incoming data (IR-RD) to the modulator/demodulator module 801.

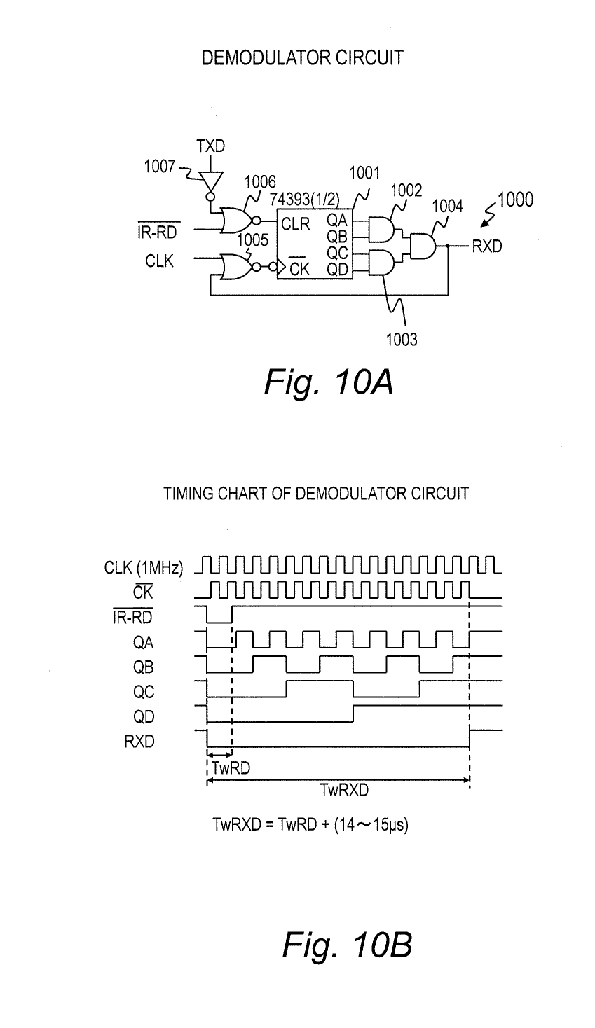

A demodulator circuit 1000 in the modulator/demodulator module 801 demodulates the received incoming data and feeds the obtained incoming data (RXD) to the microcomputer 111. The demodulator circuit 1000 will be described in detail with reference to FIGS. 10A and 10B.

For example, assuming that the microcomputer 111 and the modulator/demodulator module 801 cannot communicate data having a pulse width of less than 16 μs and that the modulator/demodulator module 801 and the infrared transmitter/receiver module 112 can communicate data having a pulse width of approximately 4 μs, the modulator circuit 900 modulates the pulse width of the transmit data from 16 μs to as short as 4 μs. This modulation can reduce the power consumption in sending data. In this case, it is also required for the demodulator circuit 1000 to demodulate the pulse width of approximately 4 μs of incoming data into that of 16 μs or more.

The modulator circuit 900 is described using FIGS. 9A and 9B.

FIG. 9A is a circuit diagram of the modulator circuit 900 in the first embodiment.

The modulator circuit 900 includes a binary counter 901, a NOT circuit 902 and an AND circuit 903.

The binary counter 901 has an CLR input for receiving transmit data (TXD) from the microcomputer 111 and an inverted CK input for receiving a clock signal (CLK) generated by the microcomputer 111, and a QA output, a QB output, a QC output, and a QD output for these inputs.

Specifically, the binary counter 901 consists of four D flip-flops. The inverted Q output of a D flip-flop is connected to the D input and the CLK input of the D flip-flop of the next stage.

If transmit data TXD at the CLR input is LOW, the binary counter 901 counts the clock signal at the inverted CK input to output binary data from the QA output, the QB output, the QC output, and the QD output. If CLR input is HIGH, the binary counter 901 outputs LOW from the QA output, the QB output, the QC output, and the QD output.

The QA output is the Q output of the D flip-flop of the first stage; the QB output is the Q output of the D flip-flop of the second stage; the QC output is the Q output of the D flip-flop of the third stage; and the QD output is the Q output of the D flip-flop of the fourth stage.

The QC output of the binary counter 901 is fed to the AND circuit 903; the QD output is fed to the AND circuit 903 via the NOT circuit 902; and the output of the AND circuit 903 is fed to the infrared transmitter/receiver module 112 as transmit data IR-TD.

FIG. 9B is a timing chart of the modulator circuit 900 in the first embodiment.

The frequency of the clock signal (CLK) is 1 MHz; if TXD at the CLR input is LOW, the modulator circuit 900 outputs the transmit data (IR-TD) to light the not-shown infrared-emitting diode at HIGH for a time shorter than the time while the TXD is LOW.

The binary counter 901 starts counting the CLK when the TXD has turned to LOW. As shown in the drawing, the QA output has a frequency of ½ of the frequency of the CLK; the QB output has a frequency of ¼ of the frequency of the CLK; the QC output has a frequency of ⅛ of the frequency of the CLK; and the QD output has a frequency of 1/16 of the frequency of the CLK.

Since the QC output and the QD output inverted by the NOT circuit 902 are fed to the AND circuit 903, the IR-TD output from the AND circuit 903 is HIGH during the time (TwTD) the QC output is HIGH and the QD output is LOW. Here, the time (TwTD) while the IR-TD is HIGH is 4 μs, which is the time while the QC output is HIGH. Through these operations, the modulator circuit 900 can modulate the time (TwTXD) of 16 μs while the TXD is LOW into 4 μs; consequently, the power consumption of the not shown infrared-emitting diode to emit infrared light can be reduced to ¼.

Next, the demodulator circuit 1000 is described using FIGS. 10A and 10B.

FIG. 10A is a circuit diagram of the demodulator circuit 1000 in the first embodiment.

The demodulator circuit 1000 includes a binary counter 1001, AND circuits 1002 to 1004, OR circuits 1005 and 1006, and a NOT circuit 1007.

The configuration of the binary counter 1001 is the same as that of the binary counter 901 in the modulator circuit 900; accordingly, the explanation thereof is omitted.

The input CLR of the binary counter 1001 receives a value of the OR the OR circuit 1006 obtains from inverted TXD fed by the NOT circuit 1007 and inverted IR-RD. The inverted CK input receives a value of the OR the OR circuit 1005 obtains from CLK representing the clock signal and RXD representing incoming data. The OR circuit 1006 and the NOT circuit 1007 are to block a signal (inverted IR-RD) indicating detection of infrared light while TXD is LOW; they prevent a signal sent by the infrared transmitter/receiver module 112 from being received and taken by the infrared transmitter/receiver 102 itself.

The AND circuit 1002 calculates an AND of the QA output and the QB output of the binary counter 1001. The AND circuit 1003 calculates an AND of the QC output and the QD output of the binary counter 1001.

The AND circuit 1004 calculates an AND of the value of the AND of the AND circuit 1002 and the value of the AND of the AND circuit 1003 and feeds the calculated AND to the microcomputer 111 as incoming data (RXD). The AND circuit 1004 also feeds the incoming data (RXD) to the OR circuit 1005.

FIG. 10B is a timing chart of the modulator circuit 1000 in the first embodiment.

The frequency of the clock signal (CLK) is 1 MHz; the modulator circuit 1000 feeds RXD to the microcomputer at LOW for a time longer than the time while the inverted IR-RD is LOW, which indicates detection of infrared light.

The binary counter 1001 starts counting the CLK when the inverted IR-RD has turned from HIGH to LOW while the TXD is HIGH. The QA output, the QB output, the QC output, and the QD output of the binary counter 1001 operate in the same way as illustrated in FIG. 9B.

The AND circuits 1002 to 1004 calculate ANDs from a QA output, a QB output, a QC output, and a QD output; output RXD of the AND circuit 1004 is LOW for 16 μs. Referring the time period while the RXD is LOW as TwRXD, the TwRXD can be obtained by adding 14 μs to 15 μs to the time period (TwRD) while the inverted IR-RD is LOW. Even if the incoming infrared signal is short, the demodulator circuit 1000 can demodulate it to have a 16-μs pulse width; accordingly, the microcomputer 111 can receive the signal (RXD) after demodulation.

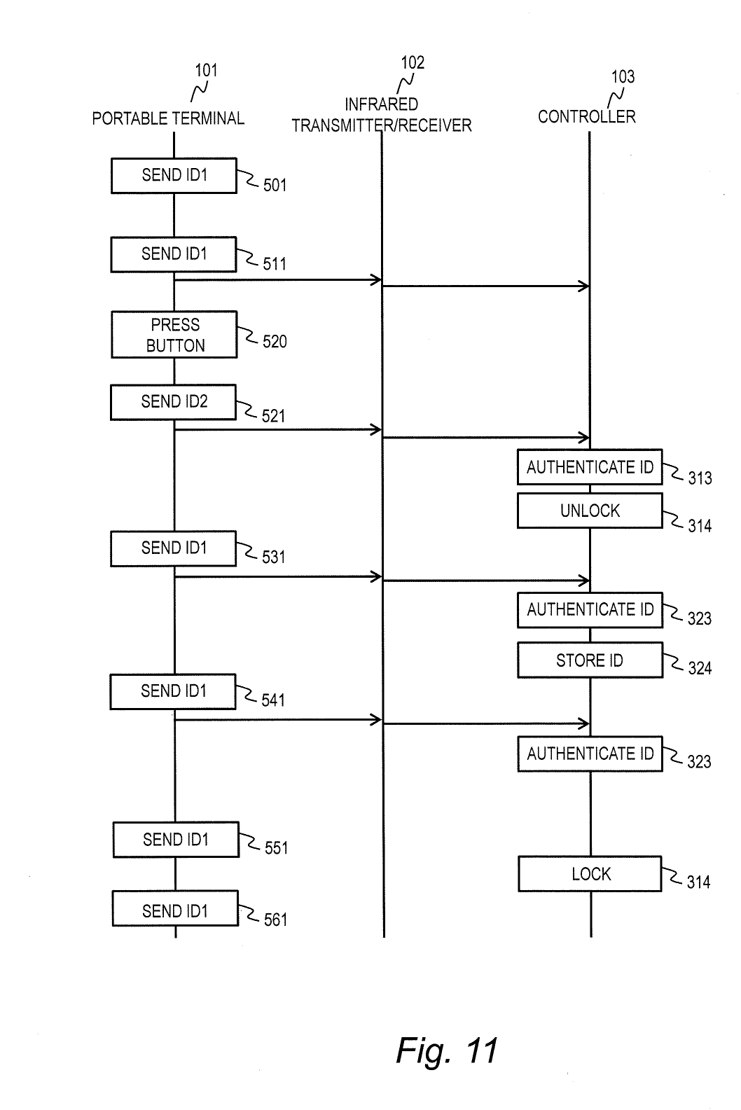

Next, a modified example of the first embodiment is explained using FIG. 11.

FIG. 11 is a sequence diagram of a modified example of the room access control system in the first embodiment.

Unlike the sequence shown in FIG. 4, the controller 103 in this modified example does not send an ID request but the portable terminal 101 periodically sends a first signal or a second signal. Furthermore, the portable terminal 101 in this modified example does not detect whether the user is walking or standing still and sends a second signal if the operation switch 116 is operated.

In the operations shown in FIG. 11, the operations same as those shown in FIG. 4 are assigned the same reference numerals and explanations thereof are omitted.

The portable terminal 101 determines whether the operation switch 116 has been operated or not when a predetermined time has passed since it sent a first signal or a second signal. If a result of the determination is that the operation switch 116 has not been operated, the portable terminal 101 sends a first signal; or if a result of the determination is that the operation switch 116 has been operated, it sends a second signal.

In FIG. 11, the portable terminal 101 determines that the operation switch 116 has not been operated, it sends a first signal including ID1 (501). However, the first signal sent at step 501 does not reach the infrared transmitter/receiver 102; the infrared transmitter/receiver 102 does not receive the first signal sent at step 501.

The portable terminal 101 determines again that the operation switch 116 has not been operated when to send the next first signal or second signal, and sends a first signal (511). The first signal sent at step 511 reaches the infrared transmitter/receiver 102 and the infrared transmitter/receiver 102 receives the first signal sent at step 511 and sends the received first signal to the controller 103. The controller 103 does not perform anything when it receives the first signal sent from the infrared transmitter/receiver 102 because the automatic door 104 is in the locked state.

Next, the portable terminal 101 detects that the operation switch 116 was operated (520). In this case, the portable terminal 101 sets an operation flag in a not shown memory to indicate the operation switch 116 was operated. The portable terminal 101 clears the flag upon sending a second signal.

At the next time to send a first or second signal, the portable terminal 101 sends a second signal including ID2 (521) because the operation flag has been set, and then clears the operation flag. Clearing the operation flag for the second signal prevents second signals from being sent many times.

The infrared transmitter/receiver 102 receives the second signal sent at step 521 and sends the received second signal to the controller 103. Upon receipt of the second signal, the controller 103 authenticates ID2 included in the second signal at step 313. If the authentication is successful, the controller 103 controls the automatic door 104 to the unlocked state at step 314.

At the next time to send a first or second signal, the portable terminal 101 sends a first signal including ID1 (531) because the operation flag has been cleared. The infrared transmitter/receiver 102 receives the first signal sent at step 531 and sends the received first signal to the controller 103.

Upon receipt of the first signal, the controller 103 authenticates the ID1 included in the received first signal at step 323 because the automatic door 104 is in the unlocked state. If the authentication is successful, the controller 103 stores the authenticated ID1 in the log file 202 at step 324.

At the next time to send a first or second signal, the portable terminal 101 likewise sends a first signal including ID1 (541). Upon receipt of the first signal sent at step 541, the infrared transmitter/receiver 102 sends the received first signal to the controller 103. Upon receipt of the first signal, the controller 103 authenticates ID1 included in the received first signal at step 323. Even if the authentication is successful, the controller 103 does not store the ID1 in the log file 202 because the ID1 has already been stored in the log file 202.

The first signals sent at steps 551 and 561 are sent after the user has passed through the automatic door 104, the first signals do not reach the infrared transmitter/receiver 102.

When a predetermined period has passed since the controller 103 lastly received the first signal while the automatic door 104 is in the unlocked sate, the controller 103 controls the automatic door 104 to the locked state at step 340.

In the room access control system in this modified example, the portable terminal 101 consumes more power in infrared transmission but can save the power consumption in infrared receiving. If the portable terminal 101 is a type that consumes more power in infrared receiving than in infrared transmission, the room access control system of this modification can save the power consumption of the portable terminal 101.

The foregoing first embodiment explained that the portable terminal 101 sends a first signal or a second signal depending on whether the user is walking or not when the portable terminal 101 receives an ID request. The foregoing modified example of the first embodiment explained that the portable terminal 101 sends a first signal or a second signal depending on whether the operation switch 116 has been operated, at a predetermined time regardless of an ID request. However, this invention is not limited to these; the portable terminal 101 may send a first signal or a second signal depending on whether the operation switch 116 has been operated upon receipt of an ID request or send a first signal or a second signal depending on whether the user is walking at a predetermined time regardless of an ID request.

### Second Embodiment

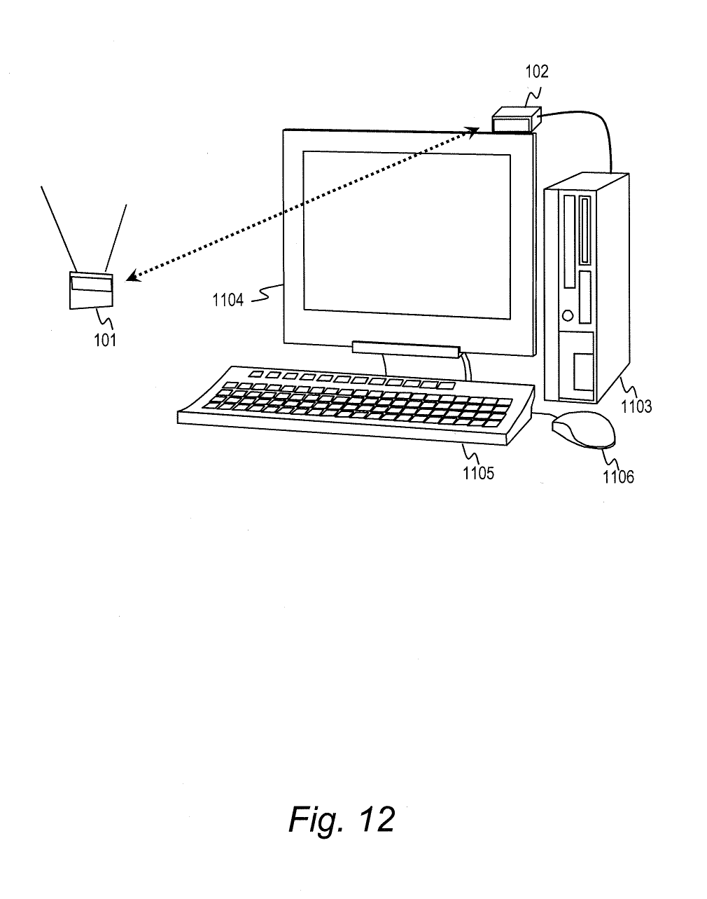

A second embodiment of this invention is described using FIGS. 12 to 15.

The first embodiment has described a room access control system in which the controller 103 controls the state of the automatic door 104; this embodiment describes a state control system for information apparatus in which a controller 103 controls the state of an information apparatus 1103 (refer to FIG. 12).

FIG. 12 is a configuration diagram of the state control system for information apparatus in the second embodiment.

The state control system for information apparatus includes a portable terminal 101, an infrared transmitter/receiver 102, an information apparatus 1103, a display 1104 of an output device, a keyboard 1105 of an input device, and a mouse 1106 of an input device. In the components shown in FIG. 12, the same components as those shown in FIG. 1 in the first embodiment are assigned the same reference signs and explanations thereof are omitted.

The functions of the controller 103 may be implemented in either one of the infrared transmitter/receiver 102 and the information apparatus 1103; this embodiment provides descriptions assuming that they are implemented in the information apparatus 1103. Accordingly, the operations of the controller 103 in the first embodiment are described as the operations of the information apparatus 1103. This embodiment provides descriptions taking a personal computer as an example of the information apparatus 1103; however, it may be a different kind of information apparatus. The functions of the infrared transmitter/receiver 102 may be implemented in the information apparatus 1103.

Like in the first embodiment, the portable terminal 101 may send a first or second signal in response to an ID request received from the information apparatus 1103 or periodically. Alternatively, the portable terminal 101 may send a first signal if it has detected that the user is walking and send a second signal if it has detected that the user is standing still. Yet alternatively, the portable terminal 101 may send a first signal if the operation switch 116 has not been operated and send a second signal if the operation switch 116 has been operated.

The information apparatus 1103 has a locked state and an unlocked state. If the information apparatus 1103 is in the locked state, it does not accept inputs from the keyboard 1105 or the mouse 1106. The information apparatus 1103 may be configured to display a specified image on the display 1104 when it is in the locked state.

When the information apparatus 1103 in the locked state receives a second signal via the infrared transmitter/receiver 102, it controls its own state into the unlocked state. The information apparatus 1103 in the unlocked state keeps its own state in the unlocked state while receiving first signals and controls it to the locked state when it has not received a first signal for a predetermined period.

In the state control system for information apparatus, when the user stands up from the seat, the information apparatus 1103 controls its own state to the locked state; when the user sits on the seat, the information apparatus 1103 controls its own state into the unlocked state. This approach saves the user's effort to enter a password to switch the state of the information apparatus 1103 into the unlocked state.

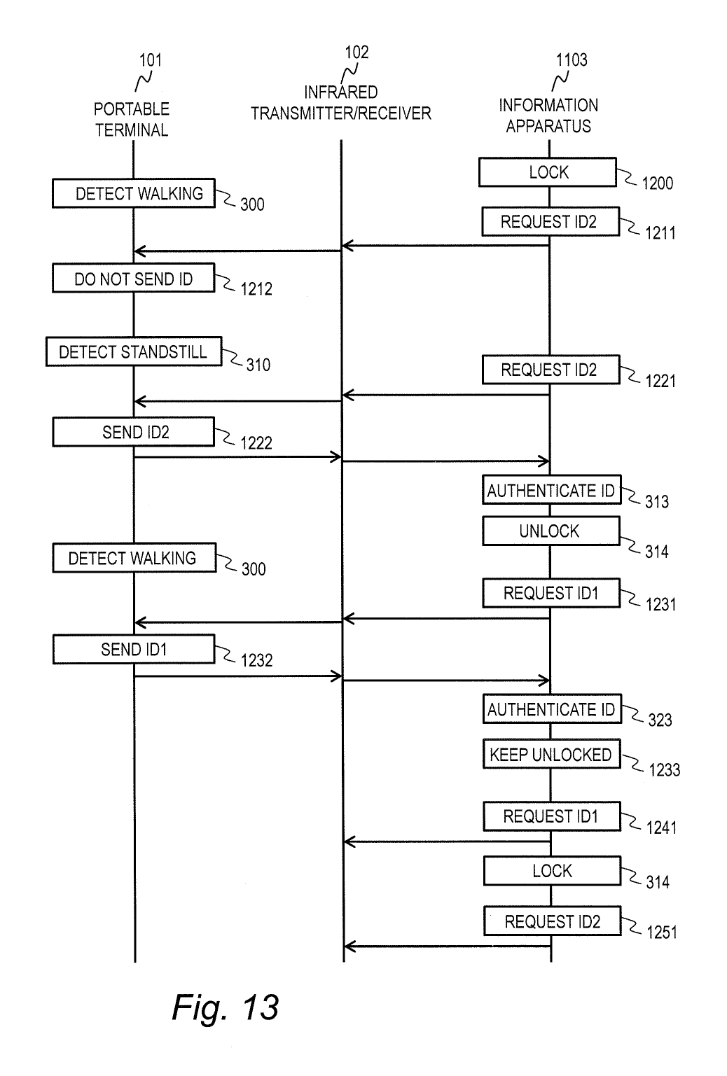

FIG. 13 is a sequence diagram of the state management system for information apparatus in the second embodiment. In the operations shown in FIG. 13, the same operations as shown in FIG. 4 in the first embodiment are assigned the same reference signs and explanations thereof are omitted.

In the sequence illustrated in FIG. 13, the information apparatus 1103 in the locked state periodically sends a request for a second signal (ID2 request) and the information apparatus 1103 in the unlocked state periodically sends a request for a first signal (ID1 request). The ID1 request and the ID2 request are generally referred to as ID request. When the portable terminal 101 receives an ID1 request, it sends a first signal including ID1 regardless of whether or not the user is walking. Upon receipt of an ID2 request, the portable terminal 101 sends a second signal including ID2 if it has determined that the user is standing still; it does not send either signal if it has determined that the user is walking.

FIG. 13 explains a situation in which the information apparatus 1103 in the locked state (1200) is controlled to the unlocked state when the user takes a seat in front of the information apparatus 1103 and thereafter the information apparatus 1103 is controlled to the locked state when the user leaves the seat.

First, at step 300, the portable terminal 101 detects that the user is walking based on an acceleration measured by the acceleration sensor 113. Since the information apparatus 1103 is in the locked state, it sends an ID2 request at a predetermined time (1211).

When the portable terminal 101 receives the ID2 request via the infrared transmitter/receiver 102, it does not send either signal (1212) because it has detected the user is walking.

Next, at step 310, the portable terminal 101 detects that the user is standing still. When a predetermined time has passed since the information apparatus 1103 sent an ID2 request at step 1211, it sends another ID2 request (1221).

When the portable terminal 101 receives the ID2 request via the infrared transmitter/receiver 102, it sends a second signal including ID2 (1222) because the user is standing still.

When the information apparatus 1103 receives the second signal via the infrared transmitter/receiver 102, it authenticates the ID2 included in the second signal at step 313. If the authentication is successful, the information apparatus 1103 controls itself into the unlocked state at step 314.

Next, when a predetermined time has passed since the information apparatus 1103 sent the ID2 request at step 1221, the information apparatus 1103 sends an ID1 request (1231) because it is in the unlocked state.

When the portable terminal 101 receives the ID1 request via the infrared transmitter/receiver 102, it sends a first signal (1232).

The information apparatus 1103 authenticates the ID1 included in the received first signal at step 323. If the authentication is successful, the information apparatus 1103 keeps the unlocked state (1233).

Next, when a predetermined time has passed since the information apparatus 1103 sent the ID1 request at step 1231, the information apparatus 1103 sends another ID1 request (1241) because it is in the unlocked state.

At this time, the user is away from the seat and the portable terminal 101 does not receive the ID1 request sent at step 1241; accordingly, the portable terminal 101 does not send either signal.

When a predetermined time has passed since the information apparatus 1103 in the unlocked state received the last first signal, the information apparatus 1103 controls itself to the locked state at step 340. While the information apparatus 1103 is in the locked state, it sends an ID2 request (1251).

Through above-described operations, the portable terminal 101 achieves a smaller number of transmissions of a second signal including ID2 to save the power consumption.

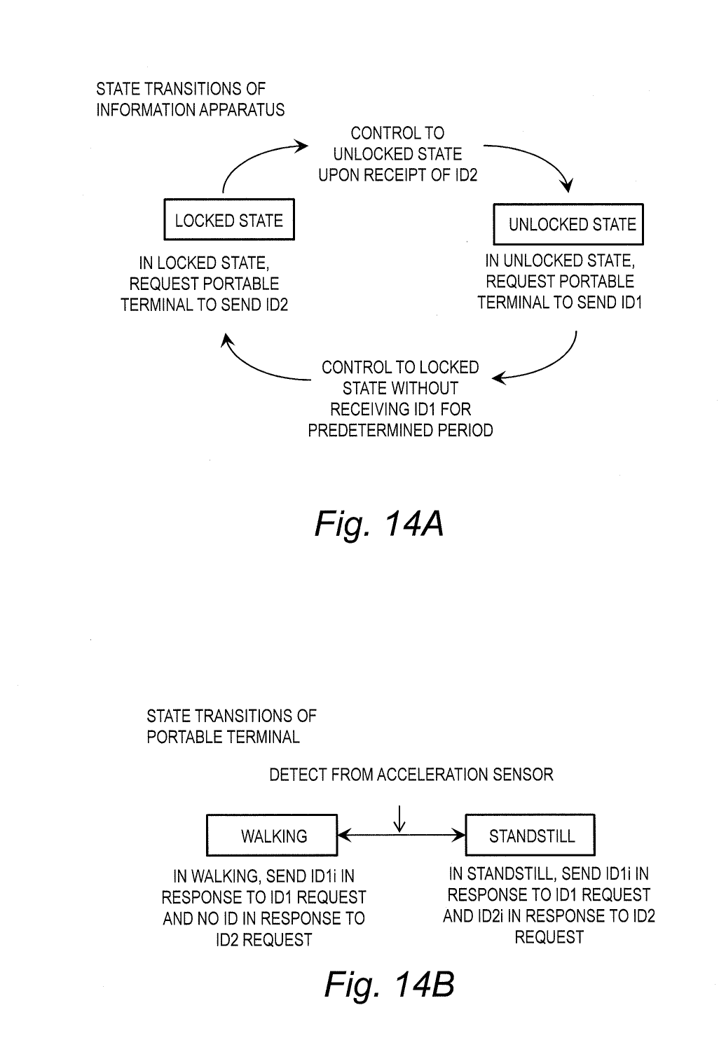

The state transitions of the information apparatus 1103 and the portable terminal 101 in the above-described second embodiment are explained using FIGS. 14A and 14B.

FIG. 14A is an explanatory diagram illustrating state transitions of the information apparatus 1103 in the second embodiment.

As described above, the information apparatus 1103 has a locked state and an unlocked state. First, the information apparatus 1103 in the locked state is described. The information apparatus 1103 in the locked state keeps the locked state until it sends an ID2 request to the portable terminal 101, receives a second signal including ID2 from the portable terminal 101, and authenticates the ID2 successfully. The information apparatus 1103 turns into the unlocked state when it receives a second signal including ID2 and authenticates the ID2 successfully.

Next, the information apparatus 1103 in the unlocked state is described. The information apparatus 1103 in the unlocked state sends ID1 requests to the portable terminal 101. The information apparatus 1103 keeps the unlocked state while it receives first signals including ID1 and authentications of the ID1 in the received first signals are successful. When the information apparatus 1103 has not received a first signal for a predetermined period, the information apparatus 1103 turns into the locked state. In addition, even if the information apparatus 1103 receives a first signal, when authentication of the ID1 in the received first signal has been failed for a predetermined period, the information apparatus 1103 also turns into the locked state.

FIG. 14B is an explanatory diagram illustrating state transitions of the portable terminal 101 in the second embodiment.

The portable terminal 101 has a walking-detected state indicating that it has detected that the user is walking and a standstill-detected state indicating that it has detected that the user is standing still.

The microcomputer 111 determines whether the user is walking or standing still based on a result of measurement by the acceleration sensor 113 to switch the state of the portable terminal 101 between these states.

The portable terminal 101 in the walking-detected state sends a first signal including ID1 upon receipt of an ID1 request and does not send a second signal including ID2 even if it receives an ID2 request. On the other hand, the portable terminal 101 in the standstill-detected state sends a first signal upon receipt of an ID1 request and sends a second signal in response to an ID2 request.

Through these operations, the portable terminal 101 in this embodiment achieves a smaller number of transmissions of a second signal to save the power consumption.

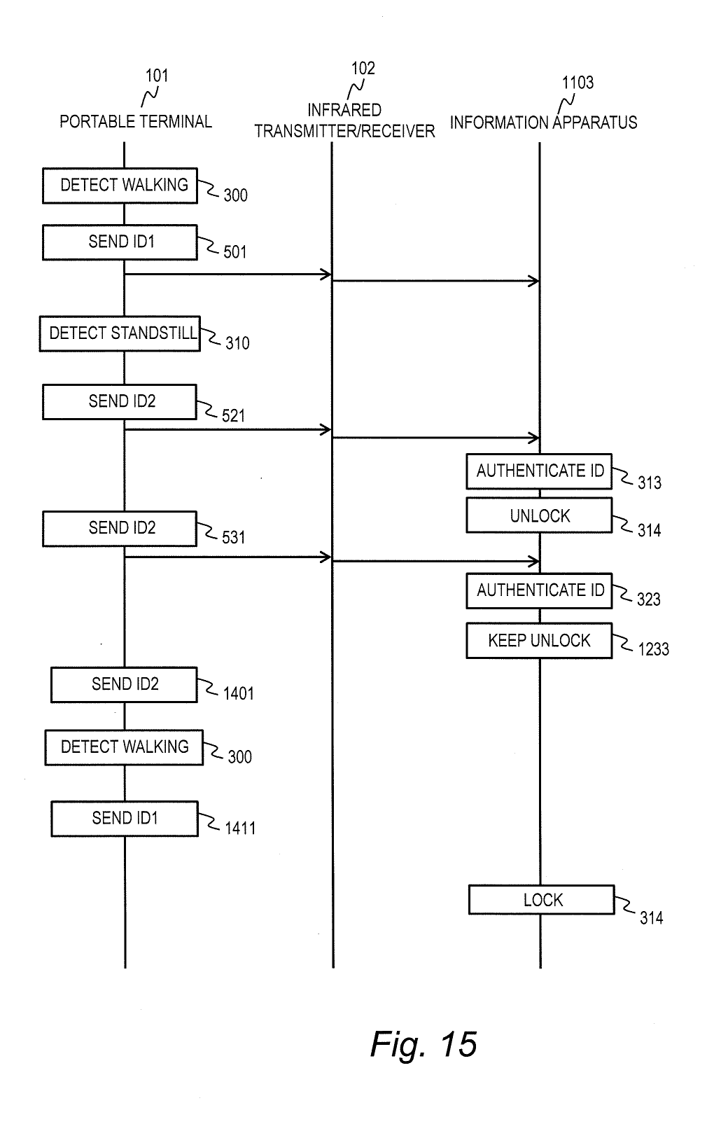

Next, a modified example of the second embodiment is described using FIG. 15.

FIG. 15 is a sequence diagram of a state control system for information apparatus in the modified example of the second embodiment. In the operations shown in FIG. 15, the operations same as those in FIG. 11 of the first embodiment are assigned the same reference signs and explanations thereof are omitted.

In this modified example, the portable terminal 101 periodically sends a first signal or a second signal like in FIG. 11 of the modified example of the first embodiment. Like FIG. 13, FIG. 15 explains a situation in which the information apparatus 1103 in the locked state is controlled to the unlocked state when the user takes a seat in front of the information apparatus 1103 and thereafter, the information apparatus 1103 is controlled to the locked state when the user leaves the seat.

First, at step 300, the portable terminal 101 detects that the user is walking. When the portable terminal 101 is to send a signal, it sends a first signal at step 501 because the user is walking. When the information apparatus 1103 receives the first signal sent at step 501 via the infrared transmitter/receiver 102, it does not perform anything because it is in the locked state.

At step 310, the portable terminal 101 detects that the user is standing still. When the portable terminal 101 is to send a next signal, it sends a second signal at step 521.

Upon receipt of the second signal sent at step 521, the information apparatus 1103 authenticates ID2 included in the received second signal at step 313. After the successful authentication, the information apparatus 1103 controls its own state from the locked state to the unlocked state at step 314.

When the portable terminal 101 is to send a next signal, it sends a second signal at step 531 because it has detected that the user is standing still. Upon receipt of the second signal sent at step 531, the information apparatus 1103 authenticates ID2 included in the received second signal at step 323. If the authentication is successful, the information apparatus 1103 keeps the unlocked state at step 1233.

At the time to send the next signal, it is assumed that the user is in motion of standing up. Even if the portable terminal 101 sends a second signal (1401), the infrared transmitter/receiver 102 does not receive the second signal.

When, thereafter, the user starts walking to leave the seat, the portable terminal 101 detects that the user is walking at step 300. At the time to send the next signal, the portable terminal 101 sends a first signal (1411).

When a predetermined time has passed since the information apparatus 1103 in the unlocked state received the last second signal, the information apparatus 1103 controls its own state from the unlocked state to the locked state at step 340.

These operations in this modified example causes the portable terminal 101 to consume more power in infrared transmissions but can save the power consumption in infrared receiving. For a portable terminal 101 that consumes more power in infrared receiving than in infrared transmission, the state control system for information apparatus in this modified example can save the power consumption of the portable terminal 101.

The foregoing first embodiment and second embodiment described the automatic door 104 and the information apparatus 1103 as examples of controlled object the state of which the control apparatus controls; however, the controlled object is not limited to these as long as it is an apparatus that can be controlled whether to be in the locked state or the unlocked state. The first embodiment and the second embodiment explained that an event for the portable terminal 101 to send a second signal is detection of the state in which the user is standing still or an operation of the operation switch 116; however, the event is not limited to these.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means for all or a part of them, may be implemented by hardware, for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, an SD card, or a DVD.

While the present invention has been described in detail and pictorially in the accompanying drawings, the present invention is not limited to such detail but covers various obvious modifications and equivalent arrangements, which fall within the purview of the appended claims.

What is claimed is:

1. A state control system comprising:
a portable terminal for sending a signal including identification information to an external; and
a control apparatus for controlling a controlled object in either one of a locked state and an unlocked state based on the signal sent from the portable terminal,
wherein the portable terminal has an event detector for detecting a predetermined event,
wherein the portable terminal sends a first signal in a case where the event detector has not detected the event,
wherein the portable terminal sends a second signal having a data length longer than a data length of the first signal, in a case where the event detector has detected the event,
wherein the control apparatus controls the controlled object to the unlocked state in a case where the controlled object is in the locked state and the controlled apparatus receives the second signal from the portable terminal, and
wherein the control apparatus controls the controlled object to the locked state in a case where the controlled object is in the unlocked state and the controlled apparatus has received neither the first signal nor the second signal for a predetermined period from the portable terminal.

2. A state control system according to claim 1,
wherein the control apparatus sends a request for a signal to the portable terminal at a predetermined time, and
wherein the portable terminal sends either one of the first signal and the second signal based on a result of detection of the event by the event detector upon receipt of the request for a signal.

3. A state control system according to claim 1,
wherein the control apparatus sends a request for a first signal to the portable terminal in a case where the controlled object is in the unlocked state,
wherein the control apparatus sends a request for a second signal to the portable terminal in a case where the controlled object is in the locked state,
wherein the portable terminal sends the first signal in a case where the portable terminal receives the request for a first signal, and
wherein the portable terminal sends the second signal in a case where the portable terminal receives the request for a second signal and the event detector has detected the event.

4. A state control system according to claim 1,
wherein the portable terminal further has an acceleration sensor for measuring an acceleration, and
wherein the event detector detects that a holder of the portable terminal is standing still as the predetermined event based on a result of measurement by the acceleration sensor.

5. A state control system according to claim 1,
wherein the portable terminal sends the first signal without encrypting the first signal and sends the second signal after encrypting the second signal.

6. A state control system according to claim 1,
wherein the portable terminal sends either one of the first signal and the second signal via infrared,
wherein the control apparatus controls the controlled object to the unlocked state in a case where the control apparatus receives the second signal and authenticates the identification information included in the second signal successfully.

7. A state control system according to claim 6,
wherein the portable terminal sends either one of the first signal and the second signal by lighting an infrared-emitting element, and
wherein the portable terminal uses a binary counter for reducing a pulse width to light the infrared-emitting element.

8. A state control system according to claim 1,
wherein the control apparatus stores identification information included in the first signal received while the controlled object is in the unlocked state.

9. A state control method of controlling a state of a controlled object in a state control system for controlling the controlled object in either one of a locked state and an unlocked state,
the state control system including:
a portable terminal for sending a signal including identification information to an external; and
a control apparatus for controlling the controlled object in either one of the locked state and the unlocked state based on the signal sent from the portable terminal,
the state control methods including the steps of:
detecting, by the portable terminal, a predetermined event;
sending, by the portable terminal, a first signal in a case where the step of detecting the predetermined event has not detected the event;
sending, by the portable terminal, a second signal having a data length longer than a data length of the first signal, in a case where the step of detecting the predetermined event has detected the event;
controlling, by the control apparatus, the controlled object to the unlocked state in a case where the controlled object is in the locked state and the controlled apparatus receives the second signal from the portable terminal; and
controlling, by the control apparatus, the controlled object to the locked state in a case where the controlled object is in the unlocked state and the controlled apparatus has received neither the first signal nor the second signal from the portable terminal for a predetermined period.

10. A state control method according to claim 9, further including the step of sending, by the control apparatus, a request for a signal to the portable terminal at a predetermined time,
wherein, in the step of sending the first signal, the portable terminal sends the first signal based on a result of the step of detecting predetermined the event upon receipt of the request for a signal,
wherein, in the step of sending the second signal, the portable terminal sends the second signal based on a result of the step of detecting predetermined the event upon receipt of the request for a signal.

11. A state control method according to claim 9, further including the steps of:
sending, by the control apparatus, a request for a first signal to the portable terminal in a case where the controlled object is in the unlocked state; and
sending, by the control apparatus, a request for a second signal to the portable terminal in a case where the controlled object is in the locked state,
wherein, in the step of sending the first signal, the portable terminal sends the first signal in a case where the portable terminal receives the request for a first signal, and
wherein, in the step of sending the second signal, the portable terminal sends the second signal in a case where the portable terminal receives the request for a second signal and the step of detecting the predetermined event has detected the event.

12. A state control method according to claim 9,
wherein the portable terminal further has an acceleration sensor for measuring an acceleration, and
wherein, in the step of detecting the predetermined event the portable terminal detects that a holder of the portable terminal is standing still as the predetermined event based on a result of measurement by the acceleration sensor.

13. A state control method according to claim 9,
Wherein, in the step of sending the first signal, the portable terminal sends the first signal without encrypting the first signal, and
Wherein, in the step of sending the second signal, the portable terminal sends the second signal after encrypting the second signal.

14. A state control method according to claim 9,
Wherein, in the step of sending the first signal and in the step of sending the second signal, the portable terminal sends the first signal and the second signal via infrared, and
wherein, in the step of controlling the controlled object to the unlocked state, the control apparatus controls the controlled object into the unlocked state in a case where the control apparatus receives the second signal and authenticates the identification information included in the second signal successfully.

15. A state control method according to claim 14,
Wherein, in the step of sending the first signal and in the step of sending the second signal, the portable terminal sends the first signal and the second signal by lighting an infrared-emitting element, and
Wherein, in the step of sending the first signal and in the step of sending the second signal, the portable terminal use a binary counter for reducing a pulse width to light the infrared-emitting element.
